(19) United States
(12) Patent Application Publication
(10) Pub. No.: US 2007/0030516 A1
(43) Pub. Date: Feb. 8, 2007

(54) Image transfer system

(76) Inventors: Shigekazu Tsuji, Tokyo (JP); Hiroaki Uchiyama, Yamato-shi (JP); Alain Volmat, Tokyo (JP); Tetsuya Hashimoto, Inzai-shi (JP)

Correspondence Address: DICKSTEIN SHAPIRO LLP, 1825 EYE STREET NW, Washington, DC, 20006-5403, US

(21) Appl. No.: 11/497,446

(22) Filed: Aug. 2, 2006

(30) Foreign Application Priority Data
Aug. 8, 2005 (JP) 2005-229326

(51) Int. Cl. G06F 3/12

(52) U.S. Cl. 358/1.15

(57) ABSTRACT

An image transfer system includes a printer connected to a network and an information terminal device, which transfers photographed image data to the printer, the information terminal device having a wireless broadcasting device, which broadcasts to the printer, and the printer having a wireless response device, which responds at least own IP address responsive to the wireless broadcasting, the information terminal device further including an IP address obtaining device, a display device, and a wireless sending device, and the printer further including a connection start request wireless sending device and a wireless connection establishing device.

### BACKGROUND

1. Field of the Invention

The present invention relates to an image transfer system which transfers image information recorded and stored in an information terminal device such as a digital camera directly to a printer without using a personal computer so as to print out the image information. More particularly, the present invention relates to an improvement in an image transfer system which transfers image information from an image terminal device to a printer so as to print out the image information without connecting the information terminal device and the printer by using an USB cable.

2. Description of Related Art

There has been conventionally known as an image transfer system of a digital camera an image transfer system that a digital camera and a personal computer are connected via a network, so as to transfer a photographed image (for example, reference to JP2003-274274A).

Moreover, there has been known an image transfer system that a digital camera connected to a local area network (LAN) by a cable broadcasts inquiry data to a device connected to the local area network (LAN) by a cable, receives response data corresponding to the inquiry data from the device connected to the LAN, extracts an IP address of the device which is the sender of the response data and transfers a photographed image to the device having the extracted IP address (for example, reference to JP2004-159281A).

Furthermore, there has been known an image transfer system that an infrared communication device is provided in a digital camera and a printer, respectively, so as to directly transfer a photographed image of the digital camera to the printer by using the infrared communication device and to print out the photographed image (for example, reference to JP2004-96761A).

Still further, there has been known an image transfer system that a digital camera and a printer over the network are wirelessly connected to establish the communication, so as to transfer photographed image information of the digital camera to the printer and to print out the photographed image (for example, reference to JP2004-328269A).

In the above explained systems, photographed image information of a digital camera is directly transferred to a printer, so as to print out the image information without using a personal computer, and also, wireless communication can be established between the digital camera and the other side of the wireless communication without using complicated setting operations.

By the way, a printer connected to a local area network (LAN) by a cable includes a printer corresponding to PTP-IP (“Picture Transfer Protocol” over TCP/IP networks), which can conduct a wireless communication. In this printer corresponding to PTP-IP, the connection can be started only from the printer side. More particularly, a connection start request can not be sent from the digital camera side of sender when photographed image data is transferred to the destination printer from the digital camera of the sender of the photographed image data. Therefore, it requires following steps in order to establish communication by sending the connection start request from the destination printer to the digital camera of sender.

More particularly, as illustrated in FIGS. 1, 2, a digital camera 1 which is a sender of photographed image data sends UDP unicast packet data to a printer connected to a LAN cable 3, the printer 2 receives this UDP unicast packet data, the printer 2 sends a connection start request (InitCmdReq) to the digital camera 1, the digital camera 1 receives this connection start request (InitCmdReq) and sends a connection start response (InitCmAck) to the printer 2, the printer 2 receives the connection start response (InitCmdAck) and sends a connection start event request (InitEvtReq) to the digital camera 1, the digital camera 1 receives the connection start event request (InitEvtReq) and sends a connection start event response (InitEvtAct) to the printer 2, when the printer 2 receives this connection start event response, PTP-IP connection is established (PTP-IP Connection Establishment), after that, digital camera 1 transfers photographed image data to the printer 2.

However, as shown in FIG. 3, when many of printers 2 corresponding to PTP-IP exist over the network, if the digital camera 1 which is the sender of photographed image data sends UDP unicast packet data to the printer 2 connected to the LAN cable, a plurality of printers 2 substantially simultaneously receives the UDP unicast packet data, a plurality of printers 2 sends the connection start requests (InitCmdReq) to the digital camera 1. When the digital camera 1 receives these connection start requests (InitCmdReq), the digital camera 1 may be disordered.

In order to avoid the above disorder, it is necessary to know an IP address of a printer over the local area network, which is the destination of the photographed image. For instance, if it is assumed that the photographed image of digital camera 1 is transferred to the printer 2 existing in front of a user in a plurality of printers 2 corresponding to PTP-IP, so as to print out the image, it is not always true that the IP address of the specific printer existing in front of the eyes is known. Therefore, it is considered that the IP address of the specific printer 2 existing in front of the eyes is informed by a network manager which manages the network 3, for example, and the IP address of the destination printer 2 existing in front of the eyes is input to the digital camera 1 of the sender to register the IP address.

However, if the above steps are not performed, the photographed image can not be transferred to the specific printer 2, so as to print out the image. Therefore, if the network manager is absence, for example, the image data can not be transferred to the printer, so as to print out the image; thus, it is extremely inconvenience.

### SUMMARY

The present invention has been made in view of the above circumstances, and an object of the present invention is to provide an image data transfer system, which can designate a specific printer and establish wireless communication between the printer and an information terminal device without conducting complicated setting operations, when a plurality of printers corresponding to PTP-IP exists over a network.

It is another object of the present invention to provide an image data transfer system which can easily obtain an IP address of a printer which is the other side of communication.

It is still another object of the present invention to provide an image data transfer system which can easily obtain capability or the like of a printer which is the other side of communication.

In order to achieve the above object, a first aspect of the present invention is directed to an image transfer system comprises a printer connected to a network and an information terminal device, which transfers photographed image data to the printer, the information terminal device including a wireless broadcasting device, which broadcasts to the printer, and the printer including a wireless response device, which responds at least own IP address responsive to the wireless broadcasting, the information terminal device further including an IP address obtaining device, which receives the response of the printer and obtains the IP address, a display device, which displays the printer corresponding to the IP address obtained by the IP address obtaining device, and a wireless sending device, which wirelessly sends unicast packet data to the printer selected by selecting the printer displayed with the display device, and the printer further including a connection start request wireless sending device, which receives the unicast packet data and wirelessly sends a connection start request to the information terminal device, and a wireless connection establishing device, which establishes wireless connection based on a response from the information terminal device relative to the connection start request, wherein after the establishment of the wireless connection, the information terminal device transfers the photographed image data to the designated printer so as to print out the photographed image.

According to the first aspect of the present invention, the image transfer system, which can designate a specific printer and establish the wireless communication between the printer and the information terminal device without conducting complicated setting operations, when a plurality of printers corresponding to PTP-IP exists over the network, can be provided.

The following (1) to (4) are preferred embodiments of the image transfer system according to the present invention. Any combinations of (1) to (4) are also preferred embodiments of the image transfer system according to the present invention, unless any contradiction occurs.

(1) The wireless broadcasting device and the wireless response device comprise a Bluetooth (R) device, respectively, the IP address of the printer is written in a free space of a format of Bluetooth (R) of the printer, and the wireless broadcasting device functions as the IP address obtaining device which obtains the IP address of the printer.

According to the above structure, even when many printers corresponding to PTP-IP exist over the network, an IP address of a printer can be obtained limited to the IP address of the printer existing in the vicinity of the information terminal device.

(2) The wireless broadcasting device and the wireless response device comprise an infrared wireless sending and receiving device, respectively, and the infrared wireless sending and receiving device functions as the IP address obtaining device which obtains the IP address of the printer.

According to the above structure, even when many printers corresponding to PTP-IP exist over the network, an IP address of a printer can be obtained limited to the IP address of the specific printer.

(3) The IP address of the printer is displayed on the display device.

According to the above structure, since the IP address of the printer is displayed on the display device, the IP address of the printer can be known without searching the IP address by a computer. Therefore, it is convenience for a local area manager or the like.

(4) A capability of the printer is written in the free space of the format of the Bluetooth (R), and the display device displays the capability of the printer.

According to the above structure, since the capability of the printer is displayed, a printer for printing out photographed image can be easily selected.

A second aspect of the present invention is directed to an image transfer system comprises a plurality of printers connected to a local area network, at least one server registered with an IP address of each of the printers and connected to the local area network and an information terminal device, which transfers photographed image data to the printer, the information terminal device including a registration device which registers an IP address of the server and a wireless sending device which requests the IP address of the printer to the server, and the server including a wireless sending device, which wirelessly sends the IP address of the printer to the information terminal device responsive to the request of the information terminal device, the information terminal device further including an IP address obtaining device, which receives a response of the printer and obtains the IP address, a display device, which displays the printer corresponding to the IP address obtained by the IP address obtaining device, and a wireless sending device, which wirelessly sends unicast packet data to the printer selected by selecting the printer displayed by the display device, and the printer including a connection start request wireless sending device, which receives the unicast packet data and wirelessly sends a connection start request to the information terminal device and a wireless connection establishing device, which establishes wireless connection based on a response from the information terminal device relative to the connection start request, wherein after the establishment of the wireless connection, the information terminal device transfers the photographed image data to a designated printer, so as to print out the photographed image.

The following (1) to (3) are preferred embodiments of the image transfer system according to the present invention. Any combinations of (1) to (3) are also preferred embodiments of the image transfer system according to the present invention, unless any contradiction occurs.

(1) The server comprises one server, and the information terminal device sends the unicast packet data to the network and obtains the IP address of each of the printers.

(2) The server comprises a plurality of servers, and the information terminal device obtains the IP address of each of the severs by broadcasting to the network, sends the unicast packet data to a specific server, and obtains the IP address of each of the printers registered and stored in the specific server.

(3) The sever obtains the IP addresses of the plurality of printers connected to the network by a UPnP device.

According to the above structures, as the structure set forth in the first aspect of the present invention, the image transfer system, which can designate a specific printer and establish the wireless communication between the printer and the information terminal device without conducting complicated setting operations, when a plurality of printers corresponding to PTP-IP exists over the network, can be provided.

The present application is based on and claims priorities from Japanese application No. 2005-229326, filed on Aug. 8, 2005, the disclosures of which are hereby incorporated by reference herein in their entirety.

### BRIEF DESCRIPTION OF THE DRAWINGS

FIG. 1 is a schematic diagram explaining a concept of direct printing out of an image transfer system using a conventional wireless LAN.

FIG. 2 is an explanation view explaining establishment of wireless communication between a conventional digital camera and printer.

FIG. 3 is a view describing failure of a conventional image transfer system.

FIG. 4 is a schematic view showing one example of local area network of image transfer system according to the present invention.

FIG. 5 is a block circuit diagram showing a major structure of digital camera according to the present invention.

FIG. 6 is a block circuit diagram illustrating a major structure of a printer according to the present invention.

FIG. 7 is a view describing an idea of Bluetooth (R) circuit according to the present invention.

FIG. 8 is a view describing an idea of IrDA circuit according to the present invention.

FIG. 9 is an explanation view of a layer structure of communication protocol according to the present invention.

FIG. 10 is a flow chart describing a general outline of image transfer system according to the present invention.

FIG. 11A is an explanation view illustrating one example of a searching screen displayed on a display monitor of digital camera according to the present invention.

FIG. 11B is a flowchart explaining one example of a searching process of an image transfer system according to the present invention.

FIG. 12 is an explanation view showing one example of a printer displayed on a display monitor of digital camera according to the present invention.

FIG. 13 is a communication schematic view showing one example which establishes communication by using UPnP searching process according to the present invention.

FIG. 14 is a flowchart showing one example which establishes communication by using Bluetooth (R) searching process according to the present invention.

FIG. 15A is an explanation view showing another example of printers displayed on a display monitor of a digital camera according to the present invention, and shows a state that names and color printing performance of laser printers are displayed.

FIG. 15B is an explanation view showing another example of printers displayed on a display monitor of a digital camera according to the present invention, and shows a state that names and IP addresses of a laser printer are displayed.

FIG. 15C is an explanation view showing another example of printers displayed on a display monitor of a digital camera according to the present invention, and shows a state that names and printing process speed of a laser printer are displayed.

FIG. 16 is a communication schematic view showing one example for establishing communication by using Bluetooth (R) searching process according to the present invention.

FIG. 17 is a schematic view when communication is performed by using a server according to the present invention.

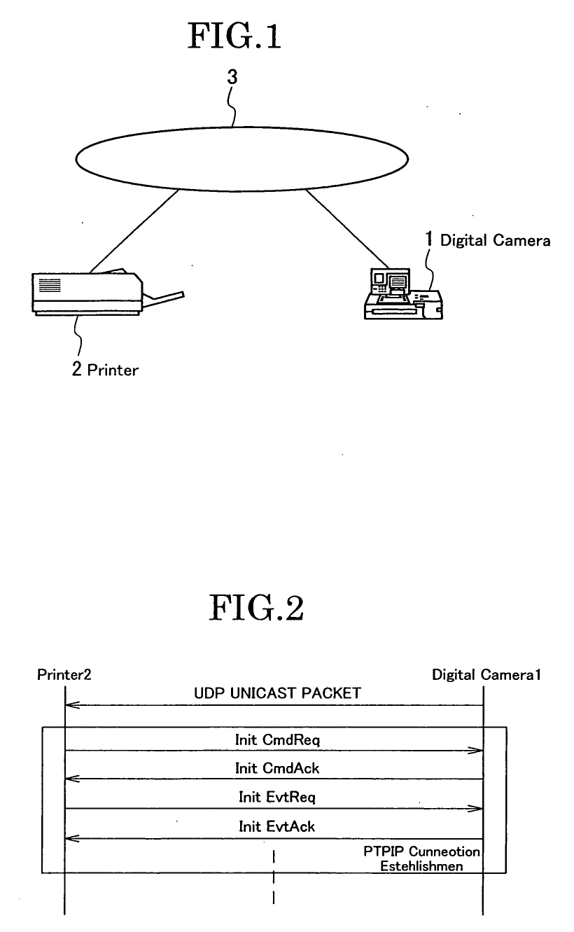

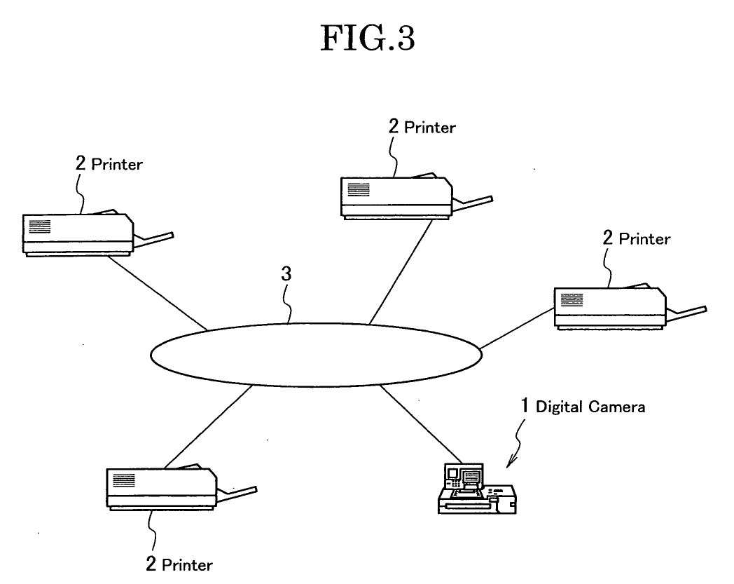

### DETAILED DESCRIPTION OF THE PREFERRED EMBODIMENTS

Hereinafter, embodiments of image transfer system according to the present invention will be explained with reference to the drawings.

### Embodiments

### First Embodiment

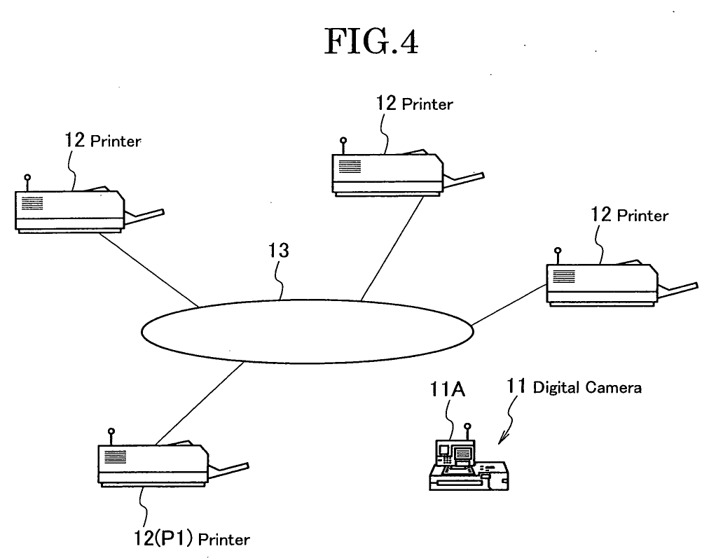

FIG. 4 is an explanation view showing an entire structure of image transfer system according to the present invention. FIG. 4 shows a digital camera 11 corresponding to PTP-IP as a portable information terminal device, printers 12 corresponding to PTP-IP and a local area network 13.

In this case, PTP (Picture Transfer Protocol) is a known communication protocol intended to transfer image data. In PTP specification, a physical layer is not specifically defined. PTP is used in “Pict Bridge” capable of directly printing out between a digital camera and a printer. In “Pict Bridge”, devices are connected by using an USB cable.

PTP-IP (“Picture Transfer Protocol” over TCP/IP networks) is a protocol which enables transfer of image data over a network of TCP/IP such as Ether net, wireless LAN or the like.

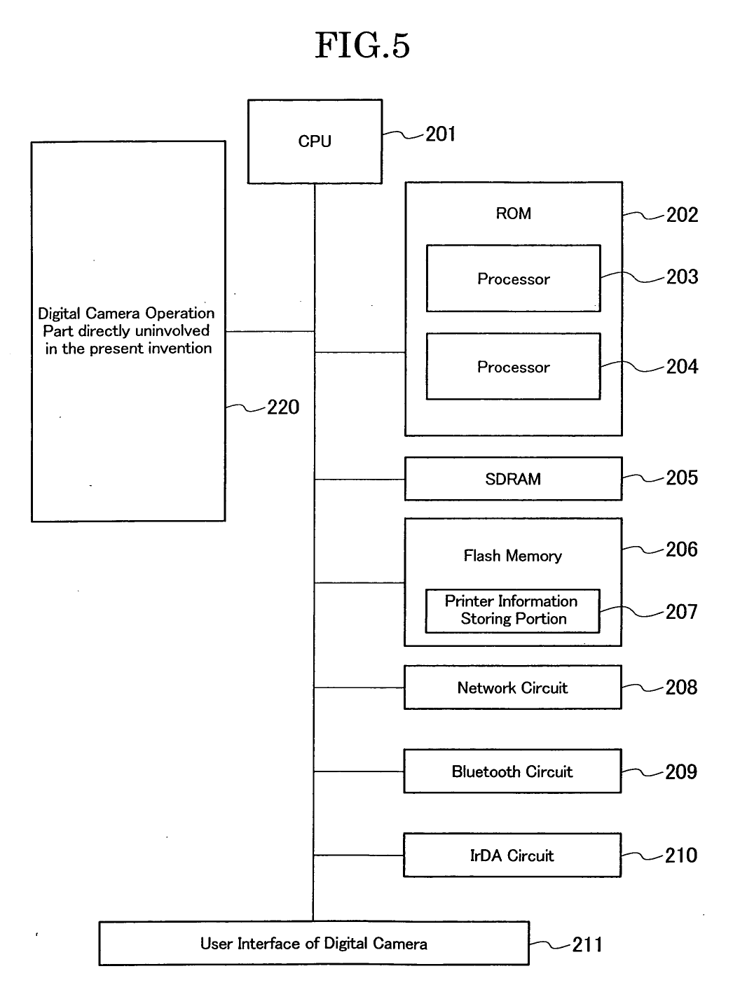

As shown in FIG. 5, the digital camera 11 comprises. a CPU 201, a ROM 202, a SDRAM 205, a flash memory 206, a network circuit 208, a Bluetooth (R) circuit 209, an IrDA circuit 210, a user interface 211 of digital camera and a remaining digital camera operation part 220. The ROM 202 comprises processors 203, 204. The flash memory 206 comprises a printer information storing portion 207.

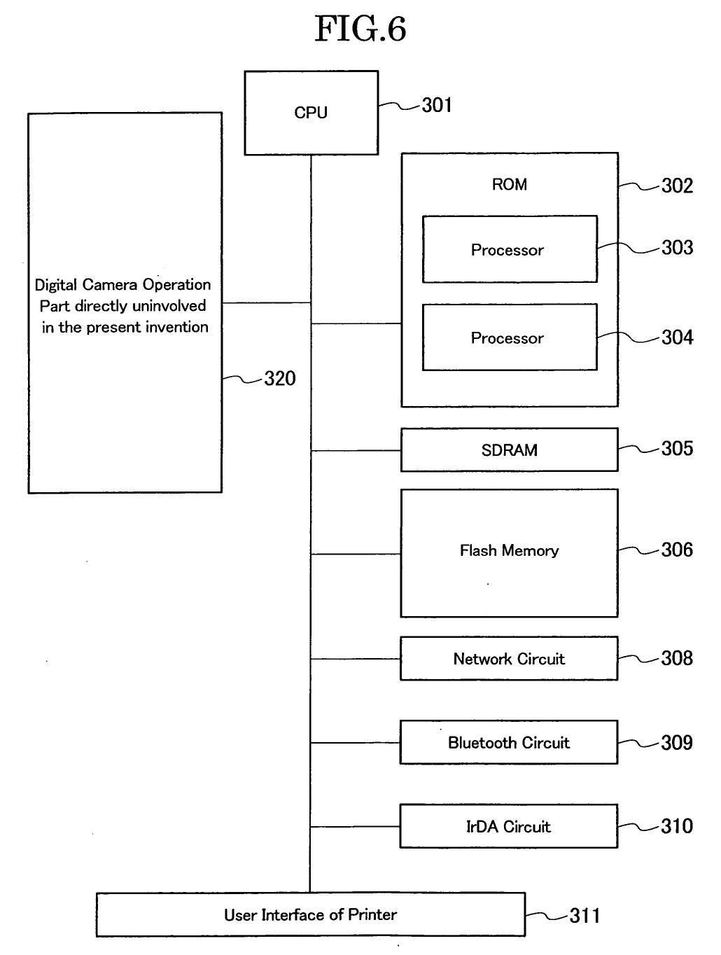

As shown in FIG. 6, the printer 12 comprises a CPU 301, a ROM 302, a SDRAM 305, a flash memory 306, a network circuit 308, a Bluetooth (R) circuit 309, an IrDA circuit 310, a user interface 311 of a printer, and a remaining printer operation part 320. The ROM 302 comprises processors 303, 304.

The digital camera 11 can be connected to the local area network 13 with a wire or without a wire. Here, it will be explained that the digital camera 11 is connected to the local area network with wireless connection. It will be also explained that the digital camera 11 operates with an infrastructure mode which requires a base station (access point), but the digital camera 11 may operate with an ad-hoc mode which directly gives and receives information of packet data with the printer 12.

In each operation mode, the digital camera 11 requires an IP address when the digital camera 11 operates over the LAN 3.

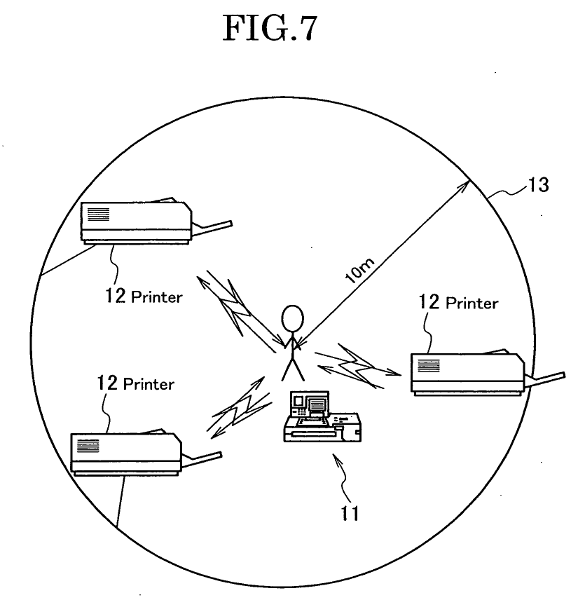

The Bluetooth (R) circuits 209, 309 can conduct wireless sending and receiving with a communication method compatible with Bluetooth (R) standard. FIG. 7 shows a schematic view of wireless sending and receiving with the communication method compatible with the Bluetooth (R) standard, and the sending and receiving range is within about 10 m radius centering on the digital camera 11.

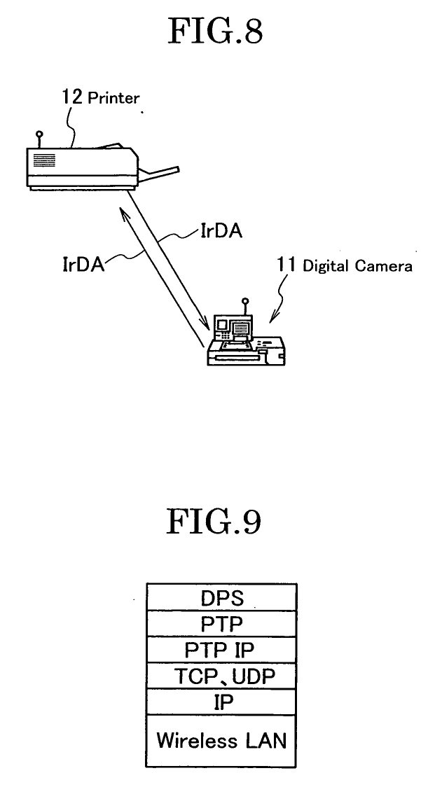

The IrDA circuits 210, 310 are infrared communication circuits which conduct wireless sending and receiving with a communication method compatible with IrDA standard. FIG. 8 is the schematic view.

In the digital camera 11 and printer 12 according to the present invention, image data photographed by the digital camera 11 can be wirelessly sent to a printer in conformity with PTP-IP.

The wireless communication protocol includes a layer structure shown in FIG. 9, and includes a structure that a connection start request is sent to the digital camera 11 only from the printer 12 side.

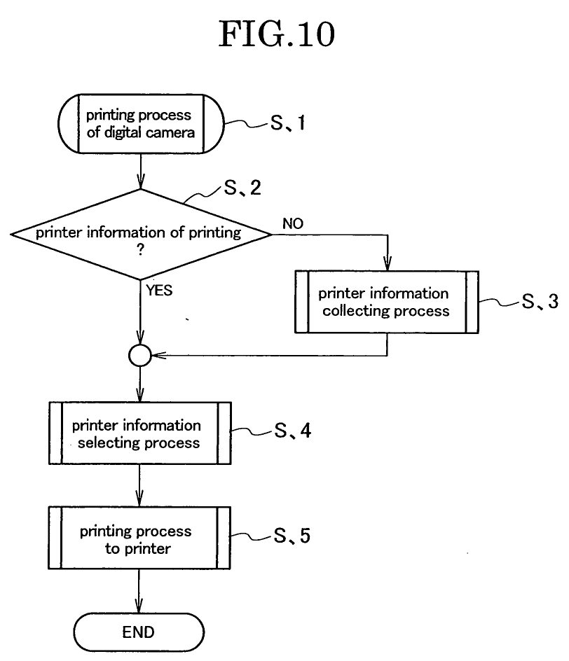

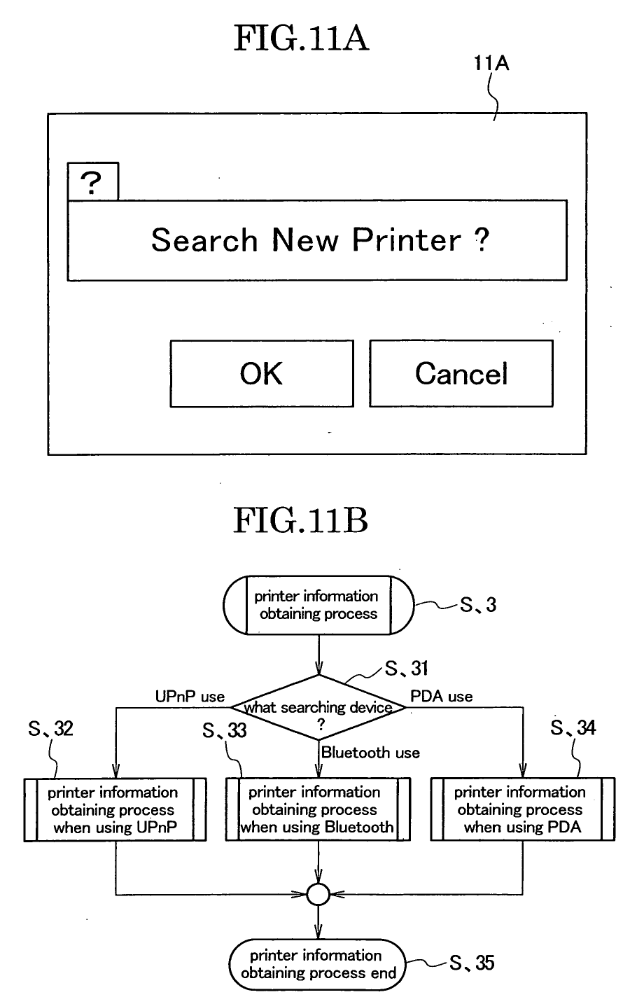

When printing out the photographed image stored in the digital camera 11, if a predetermined operation is performed, a printing process screen is displayed on a LCD monitor (display portion) 11A of the digital camera 11 (FIG. 10, S.1). Next, a screen which inquiries whether or not designation printer information is included is displayed on the LCD monitor 11A (FIG. 10, S.2). FIG. 11A shows one example of the inquiry screen.

If “OK” button is operated in the inquiry screen, the digital camera 11 moves on to a printer information obtaining process (FIG. 10, S.3). The printer information obtaining process is a process which obtains an IP address of a printer. In the printer information obtaining process, a searching device display screen which displays a searching device is displayed on the LCD monitor 11A (FIG. 11B, S31).

Letters, “UPnP use”, “Bluetooth (R) use” and “IrDA use” are displayed on the LCD monitor 11A. If the user selects the letter of “UPnP use”, and operates the “OK” button, the searching process is performed by the “UPnP use” (FIG. 11B, S.32). If the user selects the letter of “Bluetooth (R) use”, and operates the “OK” button, the searching process of “Bluetooth (R) use” is performed (FIG. 11B, S33). If the user selects the letter of “IrDA use”, and operates the “OK” button, the searching process of “IrDA use” is performed (FIG. 11, S.34). If the printer information obtaining process is completed (FIG. 11B, S.35), the digital camera moves on to a printer information selecting process (FIG. 10, S4).

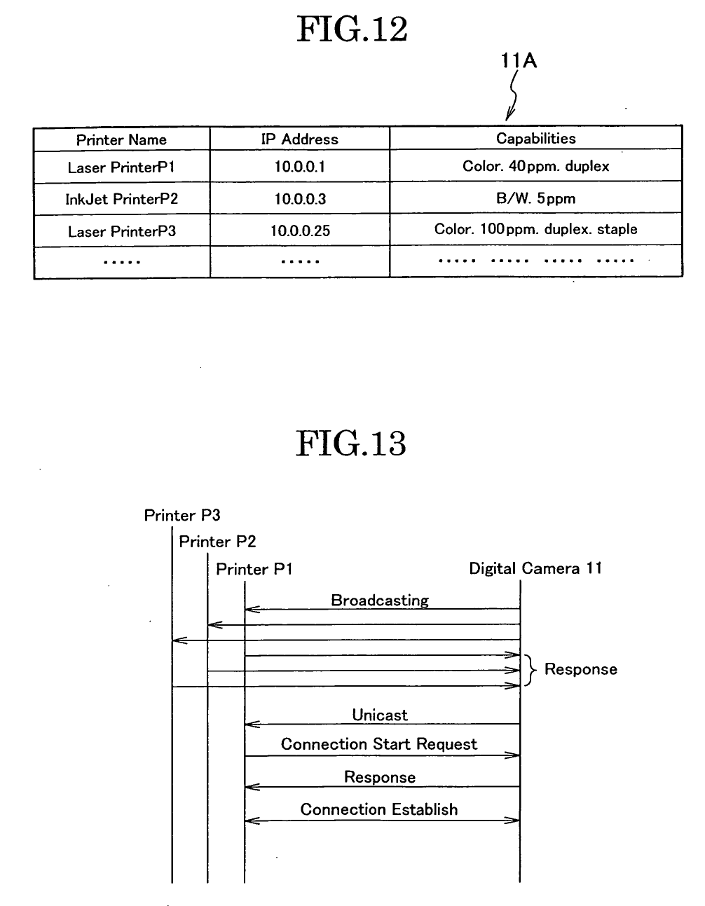

In the printer information selecting process, for example, as shown in FIG. 12, names, IP addresses, capabilities and the like of the printers corresponding to PTP-IP are displayed on the LCD monitor 11A. If the user sees the display screen of the LCD monitor 11A to select a specific laser printer, for example, a laser printer P1, and operates the “OK” button, the photographed image is transferred to the specific printer, and the image photographed by the digital camera 11 is printed out by the specific printer 12 (S.5).

Hereinbelow, it will be described about the searching process.

(Searching Process of Printer Corresponding to PTP-IP by UPnP Use)

The digital camera 11 performs UDP broadcasting (UPnP broadcasting) to each of the printers as shown in FIG. 13. In addition, UPnP is a concept that the concept of PnP (Plug and Play) is extended to a network, and UPnP is known.

Each of the printers 12 responds at least the own IP address responsive to the wireless broadcasting. Here, each of the printers 12 responds the name, capabilities and the like of the printer in addition to the own IP address. The digital camera 11 receives the response of each of the printers 12 and obtains the IP address, etc. The digital camera 11 stores the obtained IP address, etc., in the printer information storing portion 207. The obtained IP address, etc., of each of the printers 12 is displayed on the LCD monitor 11A as the display device shown in FIG. 12.

If the user selects the specific printer P1 in each of the printers P1-P3 displayed on the LCD monitor 11A, and operates the “OK” button, UDP unicast packet data is wirelessly sent to the selected printer P1.

The printer P1 receives the UDP unicast packet data and wirelessly sends a connection start request to the digital camera 11. The digital camera 11 receives the connection start request of the printer P1 and responds toward the printer P1. Thereby, the wireless connection is established. By this establishment of wireless connection, the photographed image data is transferred to the printer P1 from the digital camera 11, and the printer P1 performs the direct printing out of the photographed image.

More particularly, the CPU 201, SDRAM 205, flash memory 206, network circuit 208, user interface 211 and processors 203, 204 together function as a wireless broadcasting device which performs the UDP broadcasting toward the printers 12, an IP address obtaining device which receives the response of the printers 12 and obtains the IP addresses and a wireless sending device which wirelessly sends the UDP unicast packet data toward the printer selected by selecting the printer displayed by the display device. The LCD monitor 11A functions as a display device which displays the printer corresponding to the IP address obtained by the IP address obtaining device.

The CPU 301, SDRAM 305, flash memory 306, network circuit 308 and processors 303, 304 function as a wireless response device which responds at least own IP address responsive to the wireless broadcasting, a connection start request wireless sending device which receives the UDP unicast packet data and wirelessly sends the connection start request to the digital camera 11 and a wireless connection establishing device which establishes wireless connection based on the response from the digital camera 11 relative to the connection start request.

(Searching Process of Printer Corresponding to PTPIP by Bluetooth (R) Use)

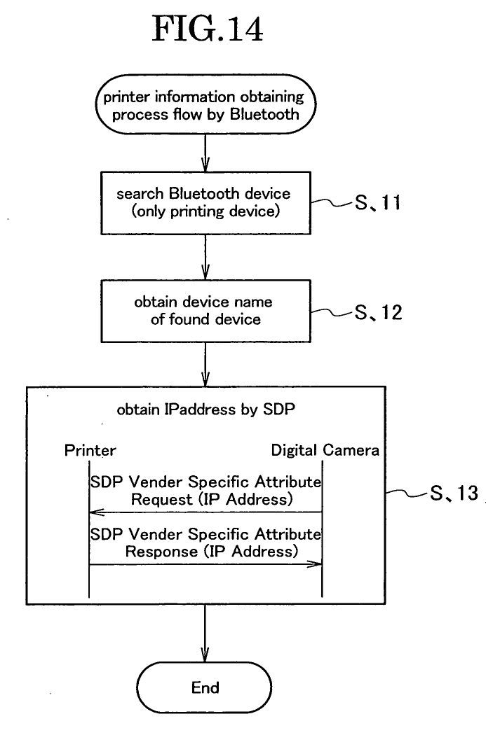

If the Bluetooth (R) searching process is selected, as shown in FIG. 14, the searching process of the printer 12 as a device physically close to the digital camera 11 is performed (S. 11). As a result of the searching, a process, which obtains the name of the printer 12 in the vicinity of the digital camera 11 (S. 12), is performed. Next, the IP address of printer 12 is obtained by using a service discovery protocol (SDP) of Bluetooth (R) (S.13).

In addition, in order to obtain the IP address, the IP address of printer 12 is previously written in the vendor area of the service discovery protocol of the printer 12 side (free space of format of Bluetooth (R) that a manufacturing company can freely use).

Thereby, the digital camera 11 can obtain the IP address of printer 12. After that, if the user selects the specific printer P1 in each of the printers P1-P3 displayed on the LCD monitor 11A, and operates the “OK” button, the UDP unicast packet data is wirelessly sent to the selected printer P1.

The printer P1 receives the UDP unicast packet data, and wirelessly sends the connection start request to the digital camera 11. The digital camera 11 receives the connection start request of the printer P1, and responds toward the printer P1. Thereby the wireless connection is established. By this establishment of wireless connection, the photographed image data is transferred to the printer P1 from the digital camera 11, and the printer P1 performs the printing out of the photographed image.

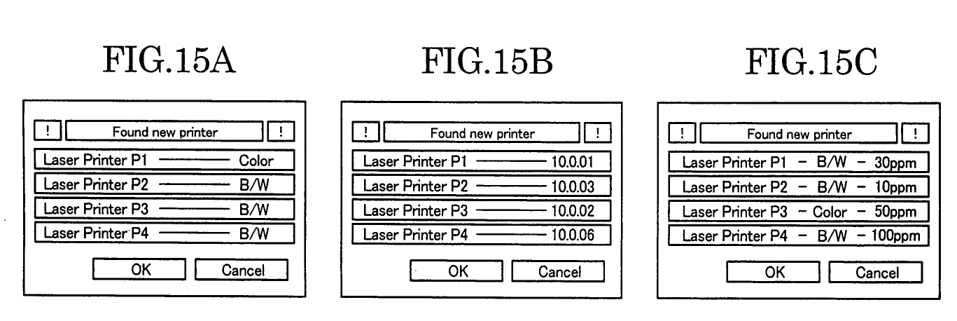

Here, as shown in FIG. 12, the structure which displays the names of laser printers, IP addresses, printer capabilities and the like is used, but the structure is not limited thereto. As shown in each of FIGS. 15A-15C, a structure which displays the printer's names and the distinction of color or monochrome, a structure which displays only the printer's names and the IP addresses and a structure which displays the printer's names, the distinction of color or monochrome and the capabilities such as processing speed may be used.

In this Bluetooth (R) searching process, the Bluetooth (R) circuits 209, 309 mainly play the roles of wireless broadcasting device and wireless response device.

If this Bluetooth (R) searching process is used, only a relatively small number of IP addresses of printers 12 corresponding to PTP-IP, which exist in 10 square meter centering on the digital camera 11 carried by the user, can be obtained, even when a lot of printers 12 corresponding to PTP-IP are connected to the local area network 13. Therefore, the selection of printer 12 corresponding to PTP-IP can be easily performed.

(Searching Process of Printer Corresponding to PTP-IP By IrDA Use)

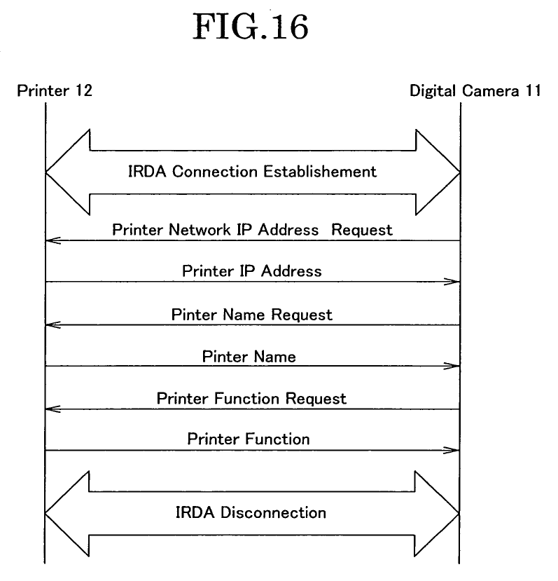

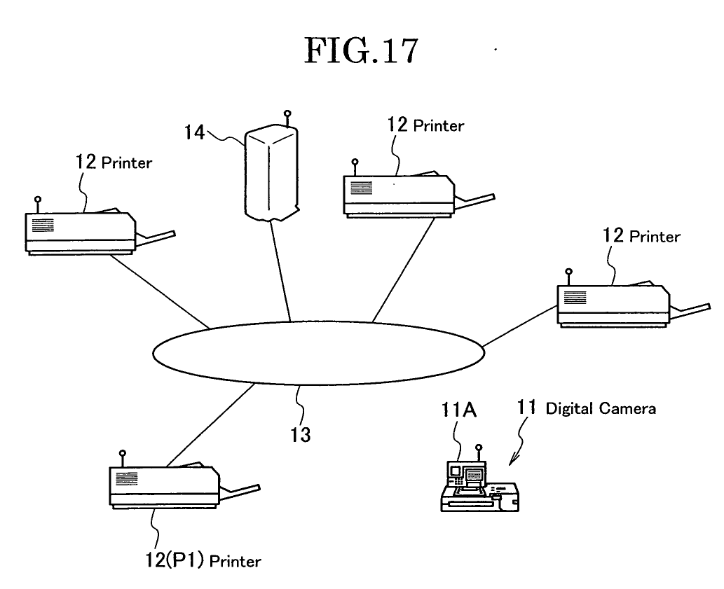

If the searching process of IrDA use is selected, as shown in FIG. 8, and brings the IrDA circuit 210 of the digital camera 11 close to the IrDA circuit 310 of the specific printer 12, the infrared sending and receiving is established as shown in FIG. 16.

Next, the digital camera 11 sends a printer network IP address request to the specific printer 12. The printer 12 sends the IP address of the printer to the digital camera 11 respective to the request.

If the digital camera 11 obtains the IP address, the camera 11 sends a printer name request. The printer 12 sends the printer's name respective to the request. If the digital camera 11 obtains the printer's name, the camera 11 sends printer function and capability requests. If the digital camera 11 obtains those, the camera 11 disconnects the infrared communication process.

The name, IP address, capabilities and the like of the printer 12 are displayed on the LCD monitor 11A as described above.

If the searching process of IrDA use is used, the communication is established between the digital camera and the specific printer. Therefore, a small amount of information including an IP address, printer's name, printer capability and the like can be quickly obtained.

In this IrDA searching process, the IrDA circuits 210, 310 mainly function as the wireless broadcasting device and wireless response device.

### Second Embodiment

This second embodiment comprises a plurality of printers 12 corresponding to PTP-IP connected to a local area network 13, a server 14 recorded with an IP address of each of the printers 12 and connected to the local area network 13, and a digital camera 11 corresponding to PTP-IP which transfers photographed image data to each of the printers 12.

The digital camera 11 comprises a registration device which registers an IP address of the server 14 and a wireless sending device which requests an IP address of the printer 12 toward the server 14. The server 14 comprises a wireless sending device which wirelessly sends the IP address of the printer 12 to the digital camera 11 responsive to the request of the digital camera 11.

The digital camera 11 comprises an IP address obtaining device which receives the response of the printer 12 and obtains the IP address, an LCD monitor 11A which displays the printer 12 corresponding to the IP address obtained by the IP address obtaining device, and a wireless sending device which wirelessly sends UDP unicast packet data to the printer 12 selected by selecting the printer 12 displayed on the LCD monitor 11A.

The printer 12 comprises a connection start request wireless sending device which receives UDP unicast packet data and wirelessly sends a connection start request to the digital camera 11 and a wireless connection establishing device which establishes wireless connection based on the response from the digital camera 11 relative to the connection start request.

The IP address of the server 14 can be previously registered by manual inputting on a setup menu screen, for example. If a single server 14 is used, the digital camera 11 may send the UDP unicast packet data to the server 14, so as to obtain the IP address of each of the printers 12.

If a plurality of servers 14 is used, the digital camera 11 may obtain the IP address of each of the servers 14 by broadcasting to the local area network 13, and send the UDP unicast packet data to the specific server 14, so as to obtain the IP address of each of the printers 12 registered and stored in the specific server 14.

Although the present invention has been described in terms of exemplary embodiments, it is not limited thereto. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An image transfer system, comprising:
a printer connected to a network; and
an information terminal device, which transfers photographed image data to the printer,
the information terminal device including a wireless broadcasting device, which broadcasts to the printer, and
the printer including a wireless response device, which responds at least own IP address responsive to the wireless broadcasting,
the information terminal device further including an IP address obtaining device, which receives the response of the printer and obtains the IP address, a display device, which displays the printer corresponding to the IP address obtained by the IP address obtaining device, and a wireless sending device, which wirelessly sends unicast packet data to the printer selected by selecting the printer displayed with the display device, and
the printer further including a connection start request wireless sending device, which receives the unicast packet data and wirelessly sends a connection start request to the information terminal device, and a wireless connection establishing device, which establishes wireless connection based on a response from the information terminal device relative to the connection start request, wherein
after the establishment of the wireless connection, the information terminal device transfers the photographed image data to the designated printer so as to print out the photographed image.

2. The image transfer system according to claim 1, wherein the wireless broadcasting device and the wireless response device comprise a Bluetooth (R) device, respectively, the IP address of the printer is written in a free space of a format of Bluetooth (R) of the printer, and the wireless broadcasting device functions as the IP address obtaining device which obtains the IP address of the printer.

3. The image transfer system according to claim 1, wherein the wireless broadcasting device and the wireless response device comprise an infrared wireless sending and receiving device, respectively, and the infrared wireless sending and receiving device functions as the IP address obtaining device which obtains the IP address of the printer.

4. The image transfer system according to claim 2, wherein the IP address of the printer is displayed on the display device.

5. The image transfer system according to claim 3, wherein the IP address of the printer is displayed on the display device.

6. The image transfer system according to claim 2, wherein a capability of the printer is written in the free space of the format of the Bluetooth (R), and the display device displays the capability of the printer.

7. An image transfer system, comprising:
a plurality of printers connected to a local area network;
at least one server registered with an IP address of each of the printers and connected to the local area network; and
an information terminal device, which transfers photographed image data to the printer,
the information terminal device including a registration device which registers an IP address of the server and a wireless sending device which requests the IP address of the printer to the server, and
the server including a wireless sending device, which wirelessly sends the IP address of the printer to the information terminal device responsive to the request of the information terminal device,
the information terminal device further including an IP address obtaining device, which receives a response of the printer and obtains the IP address, a display device, which displays the printer corresponding to the IP address obtained by the IP address obtaining device, and a wireless sending device, which wirelessly sends unicast packet data to the printer selected by selecting the printer displayed by the display device, and
the printer including a connection start request wireless sending device, which receives the unicast packet data and wirelessly sends a connection start request to the information terminal device and a wireless connection establishing device, which establishes wireless connection based on a response from the information terminal device relative to the connection start request, wherein
after the establishment of the wireless connection, the information terminal device transfers the photographed image data to a designated printer, so as to print out the photographed image.

8. The image transfer system according to claim 7, wherein the server comprises one server, and the information terminal device sends the unicast packet data to the network and obtains the IP address of each of the printers.

9. The image transfer system according to claim 7, wherein the server comprises a plurality of servers, and the information terminal device obtains the IP address of each of the severs by broadcasting to the network, sends the unicast packet data to a specific server, and obtains the IP address of each of the printers registered and stored in the specific server.

10. The image transfer system according to claim 7, wherein the sever obtains the IP addresses of the plurality of printers connected to the network by a UPnP device.
